(19) United States
(12) Patent Application Publication
(10) Pub. No.: US 2011/0276906 A1
(43) Pub. Date: Nov. 10, 2011

(54) NAVIGATIONAL INFORMATION USER INTERFACE

(75) Inventors: Shawn Lipstein, Seattle, WA (US); Jeffrey C. Dunn, Seattle, WA (US); Monica Estela Gonzalez Veron, Seattle, WA (US); Jason F. Morrill, Redmond, WA (US); Sander Viegers, Seattle, WA (US); Gail Giaccobe, Seattle, WA (US); Jonathan Fred Kern, Seattle, WA (US)

(73) Assignee: MICROSOFT CORPORATION, Redmond, WA (US)

(21) Appl. No.: 12/773,233

(22) Filed: May 4, 2010

(51) Int. Cl. G06F 3/048; G06F 3/01

(52) U.S. Cl. 715/760; 715/854; 715/809; 715/841

(57) ABSTRACT

A navigational information display panel is provided for presenting information associated with a location and relationship of a particular web page in context of hierarchical nodes above the web page. The panel may be displayed at a fixed or movable location upon activation of a navigational information control on a browsing application user interface. The panel may include various display structures representing the web page's contextual location in an effective manner along with navigational links for quick navigation to nodes above the web page (and/or at the same level).

### BACKGROUND

Web applications are becoming more popular for client/server communication. Web applications may be located on servers within an enterprise or on servers in an externally-hosted datacenter (hosted offering) and accessed by clients for a wide variety of operations. Document sharing, search, analysis, reporting, and data mining are just a few example tasks that may be performed by a typical web application. Users access a web application usually through a web browsing application that enables them to select among available documents and/or services. During the interaction, a user may be provided a number of nested web pages associated with various levels of services, documents, etc. The user may also edit and/or view documents through the browsing application with the help of a user interface that is similar to one of a local application.

In some web applications, such as those providing document sharing services, page names and their organization may be created by the users. This may result in unusual arrangements and unpredictable nesting of pages within a site. A server executing the web application may not have a way of knowing the location of a page as well as the hierarchical structure above it. Thus, the presentation to the user may also be confusing with regard to determining the location of a particular web page, relationships between web pages, and the like. Directory structures such as collapsible tree structures may be displayed in a dedicated portion of the browsing application, but that approach may consume valuable display space on the user interface. Moreover, as the number and relationships between documents become more complex, a tree structure representation of similar display may not be adequate to provide relevant information in a simple and effective manner.

### SUMMARY

This summary is provided to introduce a selection of concepts in a simplified form that are further described below in the Detailed Description. This summary is not intended to exclusively identify key features or essential features of the claimed subject matter, nor is it intended as an aid in determining the scope of the claimed subject matter.

Embodiments are directed to a navigational information display panel that may be activated through a control on a browsing application user interface providing a user with information associated with the location and relationship of a particular web page in the context of hierarchical nodes above the web page. According to some embodiments, various display structures may be employed to represent the web page's location in an effective manner along with navigational links for quick navigation to nodes above the web page (and/or at the same level).

These and other features and advantages will be apparent from a reading of the following detailed description and a review of the associated drawings. It is to be understood that both the foregoing general description and the following detailed description are explanatory and do not restrict aspects as claimed.

### BRIEF DESCRIPTION OF THE DRAWINGS

FIG. 1 is a conceptual diagram illustrating an example web application environment, where navigational information may be provided according to some embodiments;

FIG. 2 is an example browsing application user interface with a control for activating a transient navigation information panel;

FIG. 3 illustrates the example browsing application user interface of FIG. 2 with the transient navigation information panel activated;

FIG. 4 illustrates how a location of the example transient navigation information panel may be modified according to some embodiments;

FIG. 5 illustrates three example transient navigation information panels according to embodiments;

FIG. 6 is a networked environment, where a system according to embodiments may be implemented;

FIG. 7 is a block diagram of an example computing operating environment, where embodiments may be implemented; and

FIG. 8 illustrates a logic flow diagram for a process of providing a transient navigation information panel according to embodiments.

### DETAILED DESCRIPTION

As briefly described above, a navigational information display panel may be displayed through a control on a browsing application user interface providing a user with information associated with the location and relationship of the current web page in context of hierarchical nodes above the web page. A number of graphical and/or textual display structures may be employed to display the web page's location in an effective manner along with navigational links for quick navigation to nodes above the web page. The user may also be enabled to quickly navigate to any of the displayed nodes through navigational links. In the following detailed description, references are made to the accompanying drawings that form a part hereof, and in which are shown by way of illustrations specific embodiments or examples. These aspects may be combined, other aspects may be utilized, and structural changes may be made without departing from the spirit or scope of the present disclosure. The following detailed description is therefore not to be taken in a limiting sense, and the scope of the present invention is defined by the appended claims and their equivalents.

While the embodiments will be described in the general context of program modules that execute in conjunction with an application program that runs on an operating system on a personal computer, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and comparable computing devices. Embodiments may also be practiced in distributed computing environments where tasks are performed by remote processing devices that are linked through a communications network. In a distributed computing environment, program modules may be located in both local and remote memory storage devices.

Embodiments may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process(es). The computer-readable storage medium can for example be implemented via one or more of a volatile computer memory, a non-volatile memory, a hard drive, a flash drive, a floppy disk, or a compact disk, and comparable media.

Throughout this specification, the term “platform” may be a combination of software and hardware components for managing computer and network operations, which may include web applications. Examples of platforms include, but are not limited to, a hosted service executed over a plurality of servers, an application executed on a single server, and comparable systems. The term “server” generally refers to a computing device executing one or more software programs typically in a networked environment. However, a server may also be implemented as a virtual server (software programs) executed on one or more computing devices viewed as a server on the network. More detail on these technologies and example operations is provided below.

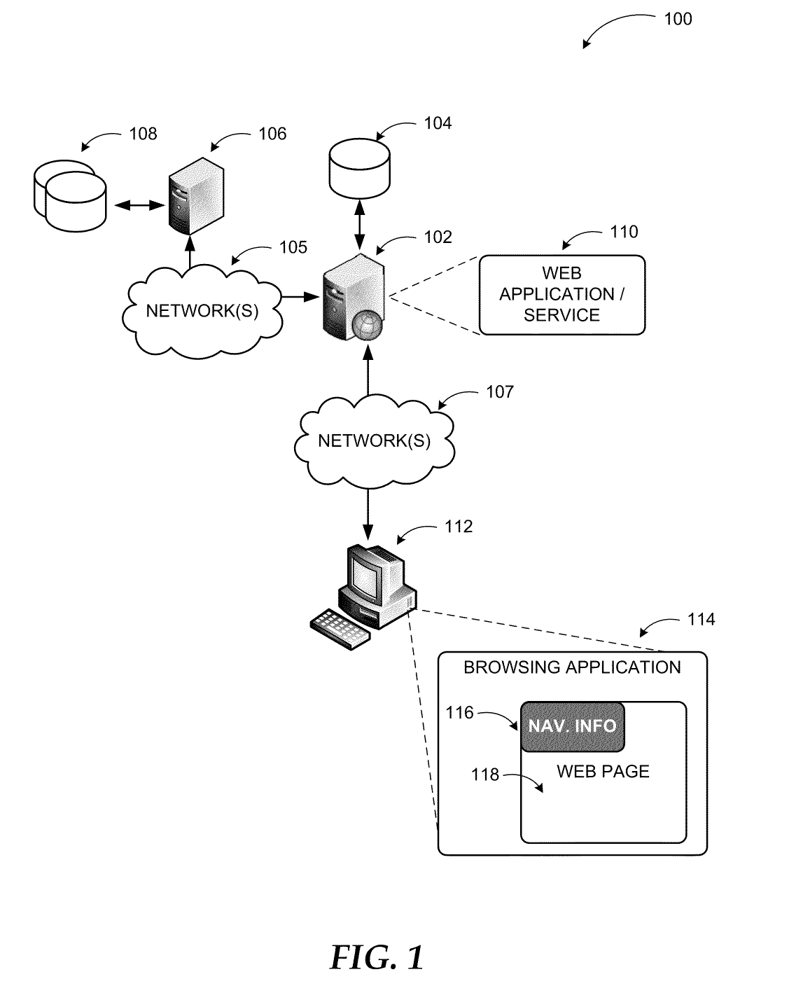

FIG. 1 includes a conceptual diagram 100 illustrating an example web application environment, where navigational information may be provided according to some embodiments. The networked web application environment shown in diagram 100 is for illustration purposes. Embodiments may be implemented in various networked environments such as enterprise-based networks, cloud-based networks, and combinations of those, as well as employing a number of other computing devices.

An example web application may be managed by one or more servers such as web server 102 executing a web application 110. Services provided by the web application 110 may be accessed by a user through browsing application 114 executed on client device 112, which may communicate with web server 102 through network(s) 107. Client device 112 may be, but is not limited to, a desktop computing device, a laptop computing device, a handheld computing device, a mobile computing device, a terminal, a smart phone, and comparable ones.

According to one example scenario, the web application 110 may provide a document sharing service, where users can store, create, edit, and delete various documents such as word processing documents, spreadsheet documents, presentation documents, and similar ones. Web application 110 may provide user interface elements for creating, editing, and deleting such documents through browsing application 114. The document sharing service may be provided to the user in web pages. For example, when the user first accesses the service, a web page (e.g. web page 118) may display a listing of available documents. The listing of documents may also be displayed through multiple web pages (e.g. categorized according to projects, teams, document types, etc.). Upon selection of a document by the user, a new web page may be presented displaying the document contents along with relevant user interface elements (controls) to manipulate the document. Documents according to the above described example scenario may be stored by the web server 102 at a local data store 104. Alternatively, documents may be stored at (and retrieved from) a number of networked resources such as other servers (106) and their associated data stores (108) through network(s) 105 by the web server 102.

As mentioned previously, navigating through available documents in a service like the one described herein may be challenging as users create large numbers of documents with complex relationships. A web application according to embodiments may enable browsing application 114 to present a navigation information control 116. Upon activating the navigation information control 116, the user may be provided location information associated with the currently displayed web page within context of its hierarchical relationships with other web pages (e.g. those above the web page's level). Furthermore, the navigation information may enable the user to navigate to any of the displayed web pages in an effective manner (e.g. by clicking on a navigational link).

The example system in FIG. 1 has been described with specific servers, client devices, software programs, and services. Embodiments are not limited to systems according to these example configurations. A navigational information user interface may be implemented in configurations employing fewer or additional components and performing other tasks. Furthermore, specific protocols and/or interfaces may be implemented in a similar manner using the principles described herein. For example, a web application employing a navigational information control may provide other services than document sharing such as media sharing, search operations, database operations, and comparable ones.

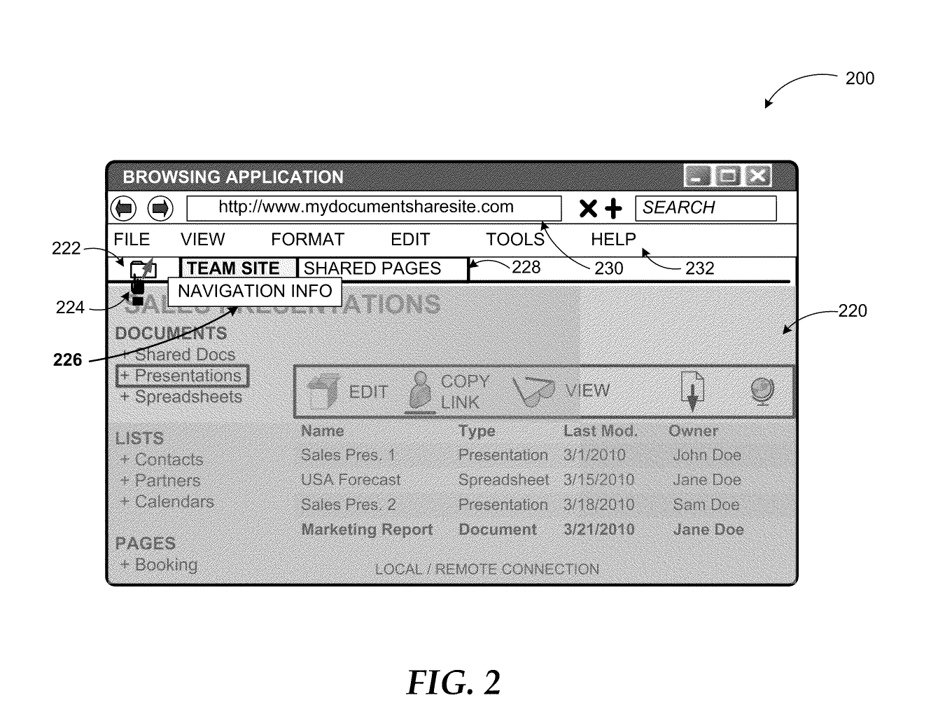

FIG. 2 is an example browsing application user interface with a control for activating a transient navigation information panel. Browsing application user interface 200 has standard user interface elements such as a text box 230 for entering the Uniform Resource Locator (URL) address of the web application, a search box, and textual or graphical controls 232 like “file”, “view”, “edit” menus, etc. The controls may provide the user a drop-down menu, a hover-on menu, or similar options for selecting various tasks associated with the browsing application user interface 200. Contents associated with the web application (e.g. documents) may be provided in a categorized manner such as by tabs (228). Other contents (220) of browsing application user interface 200 such as the example list of available documents are grayed in FIG. 2 because they are provided only to present context of the web page, and are irrelevant to the present disclosure.

In a system according to embodiments, navigational information control 222 may be provided to display a contextual location of the current web page. Navigational information control 222 may be an icon, a textual control, or any form of graphic and/or textual element. According to some embodiments, an information box 226 may be displayed to indicate a nature of the control upon user hovering over (224) the control. Information box 226 also indicates that the area is clickable surface.

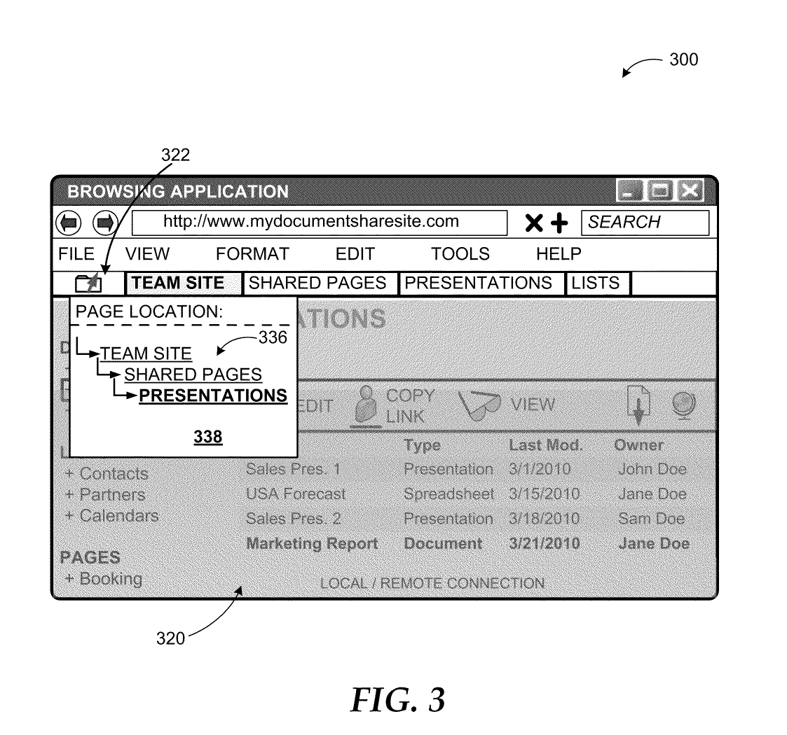

FIG. 3 illustrates the example browsing application user interface of FIG. 2 with the transient navigation information panel activated. Upon activation of the navigation information control 322 on browsing application user interface 300, transient navigation information panel 338 may be displayed presenting contextual web page location 336. Contextual web page location 336 may be presented in a number of ways as discussed in more detail below. The example presentation in FIG. 3 includes the current web page titled “Presentations” and two other web pages hierarchically above the current web page, “Shared Pages” and “Team Site”. The web pages are presented in an indented manner indicating their hierarchical relationship (i.e. “Shared Pages” is the parent page for “Presentations” and “Team Site” is the parent for “Shared Pages”).

Furthermore, each web page name is displayed as a navigational link enabling the user to click on any one of the names and directly navigate to that page. As in FIG. 2, other content 320 of browsing application 300 is grayed because they are provided for contextual purposes and are not relevant to a functionality of the transient navigational information panel 338.

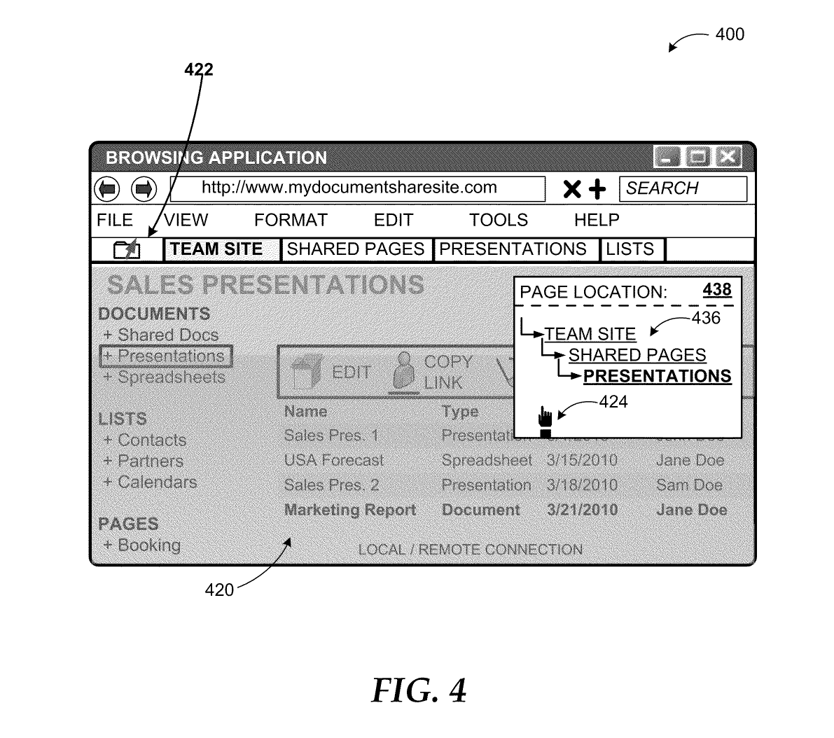

FIG. 4 illustrates how a location of the example transient navigation information panel may be modified according to some embodiments. Browsing application user interface 400 includes similar features to that shown in FIG. 3. As in FIG. 3, other content 420 of browsing application user interface 400 is grayed because they are provided for contextual purposes and are not relevant to a functionality of the transient navigational information panel 438.

Differently from FIG. 3, navigational information panel 438 displaying contextual web page location 436 is located on the right side of the web page. According to some embodiments, the navigational information panel 436 may have a fixed or movable location. For example, the panel may be displayed, upon activation of the navigational information control 422, underneath the control or at a predefined location on the web page. Alternatively, the location of the navigational information panel 438 may be determined dynamically based on displayed content on the browsing application user interface 400 (e.g. a suitable empty space). Moreover, navigational information panel 438 may be movable by user action (424). The user may be enabled to click and drag the panel to any location they desire.

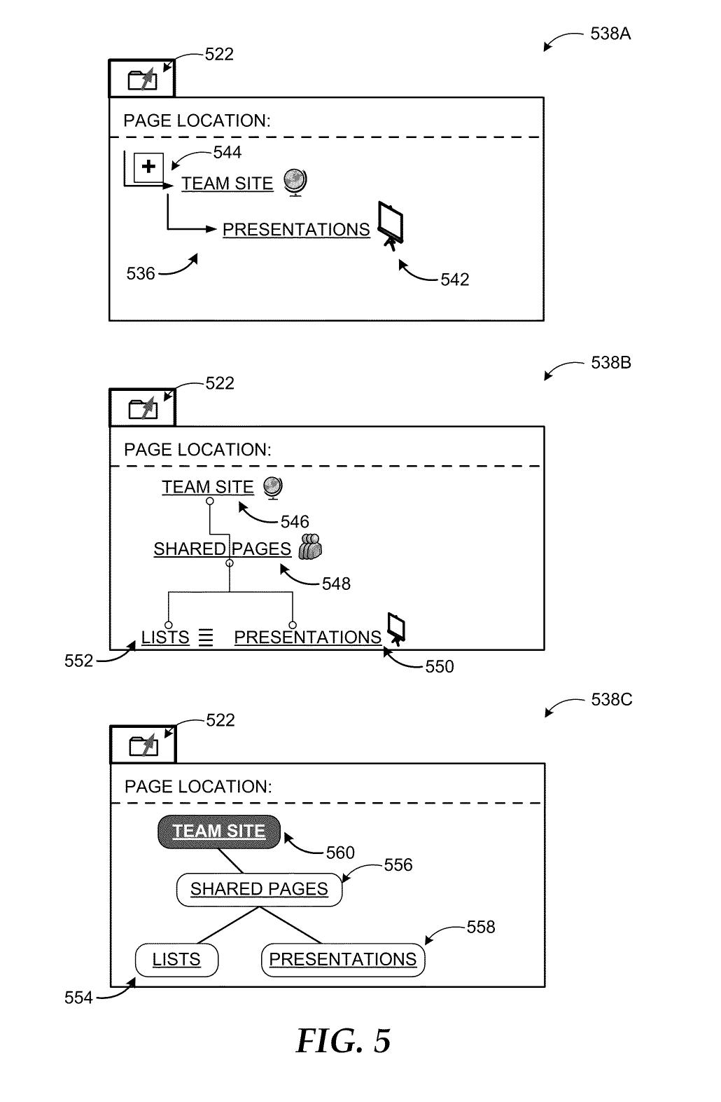

FIG. 5 illustrates three example transient navigation information panels. According to some embodiments, the appearance and disappearance of the navigation information panel may be animated to provide an aesthetically pleasing experience to the user. As discussed above, a location and an appearance of the navigation information panel may be predefined or user determined. Furthermore, the navigation information control may be located within a menu bar of the browsing application user interface or at another predefined location. The control may be disabled or hidden if the currently displayed web page does not belong to a hierarchy or is at the top of the hierarchy.

The navigation information panel itself is intended to present contextual web page location in an effective manner to the user. Thus, a number of graphical, textual, coloring, and other schemes may be employed in presenting the information within the navigation information panel.

According to the first example navigation information panel 538A, the hierarchy of web pages above the currently displayed web page (“Presentations”) may be presented in a collapsible indented list form. For example, web page(s) between the currently displayed page and the top level page (“Team Site” 544) may be collapsed into the top level web page and displayable upon user activation of an icon (or user hovering on the top level web page). In addition to the navigational links enabling the user to navigate directly to the web pages listed (536) on the navigation information panel, graphical icons 542 may be employed to identify the listed pages.

According to the second example navigation information panel 538B, the hierarchy of web pages may be presented in an organizational structure diagram along with representative icons. Top level web page “Team Site” 546 is at the top of the diagram followed by next level page “Shared Pages” 548. In this example illustration, “Lists” page 552, which has a sibling relationship to the currently displayed page “Presentations” 550 is also displayed. Thus, embodiments are not limited to web pages above the currently displayed web page in the hierarchy. Other relationships may also be presented. For example, one or more levels of child pages below the currently displayed web page may also be presented. Some or all of the listed pages may include navigational links as discussed above.

According to the third example navigation information panel 538C, the hierarchy of web pages “Team Site” 560, “Shared Pages” 556, “Lists” 554, and “Presentations” 558 are presented in a circular connected diagram with each box representing a web page (or node in the hierarchy) being a navigational link. Additionally a shading scheme (see “Team Site” 560) may be employed to accentuate the differences between the different levels or types of web pages.

The examples in FIGS. 2, 3, 4, and 5 have been described with specific document types, user interfaces, control elements, and presentation schemes. Embodiments are not limited to systems according to these example configurations. A navigational information user interface according to embodiments may be implemented in configurations using other types of documents, user interfaces, control elements, and presentation schemes in a similar manner using the principles described herein.

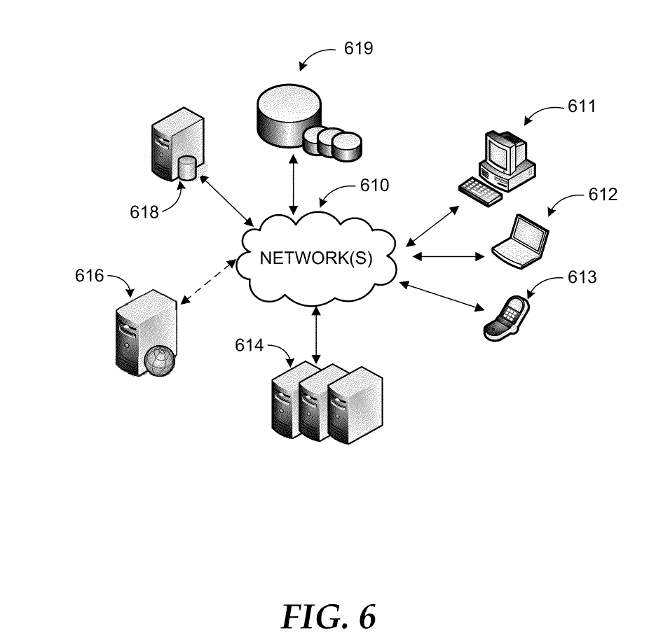

FIG. 6 is an example networked environment, where embodiments may be implemented. A platform providing a transient navigational information panel as part of a web application display may be implemented via software executed over one or more servers 614 such as a hosted service. The platform may communicate with client applications on individual computing devices such as a smart phone 613, a laptop computer 612, or desktop computer 611 (‘client devices’) through network(s) 610.

As discussed above, client applications (e.g. browsing applications) executed on any of the client devices 611-613 may enable access for a user to services provided by the servers 614, or individual server 616. The browsing application user interface may include a navigational information control. Upon activation of the navigational information control, a process may retrieve information associated with a hierarchy of the current web page and display nodes above (and/or at the same level as) the current web page further providing navigational links to the displayed nodes, as discussed previously. The service may retrieve relevant data from data store(s) 619 directly or through database server 618.

Network(s) 610 may comprise any topology of servers, clients, Internet service providers, and communication media. A system according to embodiments may have a static or dynamic topology. Network(s) 610 may include secure networks such as an enterprise network, an unsecure network such as a wireless open network, or the Internet. Network(s) 610 may also coordinate communication over other networks such as Public Switched Telephone Network (PSTN) or cellular networks. Furthermore, network(s) 610 may include short range wireless networks such as Bluetooth or similar ones. Network(s) 610 provide communication between the nodes described herein. By way of example, and not limitation, network(s) 610 may include wireless media such as acoustic, RF, infrared and other wireless media.

Many other configurations of computing devices, applications, data sources, and data distribution systems may be employed to implement a web application framework providing navigational information associated with web pages. Furthermore, the networked environments discussed in FIG. 6 are for illustration purposes only. Embodiments are not limited to the example applications, modules, or processes.

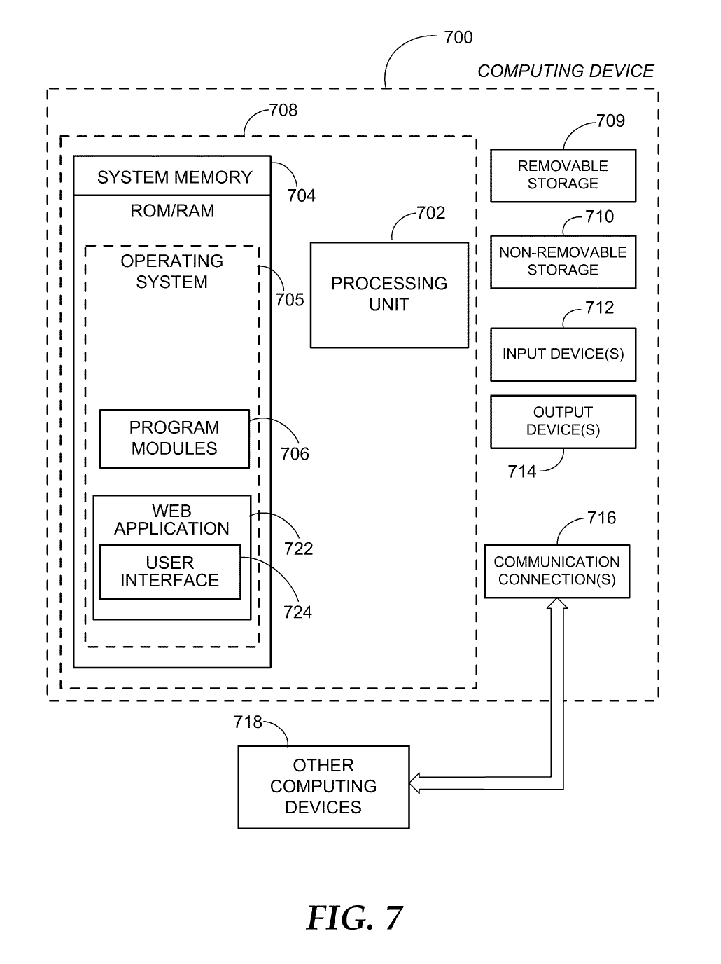

FIG. 7 and the associated discussion are intended to provide a brief, general description of a suitable computing environment in which embodiments may be implemented. With reference to FIG. 7, a block diagram of an example computing operating environment for an application according to embodiments is illustrated, such as computing device 700. In a basic configuration, computing device 700 may be a server executing a web application capable of providing web applications to client devices/applications along with navigational web page information according to embodiments and include at least one processing unit 702 and system memory 704. Computing device 700 may also include a plurality of processing units that cooperate in executing programs. Depending on the exact configuration and type of computing device, the system memory 704 may be volatile (such as RAM), non-volatile (such as ROM, flash memory, etc.) or some combination of the two. System memory 704 typically includes an operating system 705 suitable for controlling the operation of the platform, such as the WINDOWS® operating systems from MICROSOFT CORPORATION of Redmond, Wash. The system memory 704 may also include one or more software applications such as program modules 706, web application 722, and user interface module 724.

Web application 722 may be any application providing web applications in a networked environment. When accessed by a user through their browsing application on a client device, user interface module 724 of web application 722 may provide functionality associated with control elements of the browsing application. One such control element may be a navigational information button (or textual element). Upon activation of the navigational information control, user interface module 724 may retrieve hierarchical information associated with a currently displayed web page and enable display of a transient navigational information panel presenting nodes above and/or at the same level as the displayed web page and enabling the user to navigate to any of the nodes by selecting the displayed link. Web application 722 and user interface module 724 may be separate applications or an integral component of a hosted service. This basic configuration is illustrated in FIG. 7 by those components within dashed line 708.

Computing device 700 may have additional features or functionality. For example, the computing device 700 may also include additional data storage devices (removable and/or non-removable) such as, for example, magnetic disks, optical disks, or tape. Such additional storage is illustrated in FIG. 7 by removable storage 709 and non-removable storage 710. Computer readable storage media may include volatile and nonvolatile, removable and non-removable media implemented in any method or technology for storage of information, such as computer readable instructions, data structures, program modules, or other data. System memory 704, removable storage 709 and non-removable storage 710 are all examples of computer readable storage media. Computer readable storage media includes, but is not limited to, RAM, ROM, EEPROM, flash memory or other memory technology, CD-ROM, digital versatile disks (DVD) or other optical storage, magnetic tape, magnetic disk storage or other magnetic storage devices, or any other medium which can be used to store the desired information and which can be accessed by computing device 700. Any such computer readable storage media may be part of computing device 700. Computing device 700 may also have input device(s) 712 such as keyboard, mouse, pen, voice input device, touch input device, and comparable input devices. Output device(s) 714 such as a display, speakers, printer, and other types of output devices may also be included. These devices are well known in the art and need not be discussed at length here.

Computing device 700 may also contain communication connections 716 that allow the device to communicate with other devices 718, such as over a wired or wireless network in a distributed computing environment, a satellite link, a cellular link, a short range network, and comparable mechanisms. Other devices 718 may include computer device(s) that execute communication applications, other web servers, and comparable devices. Communication connection(s) 716 is one example of communication media. Communication media can include therein computer readable instructions, data structures, program modules, or other data. By way of example, and not limitation, communication media includes wired media such as a wired network or direct-wired connection, and wireless media such as acoustic, RF, infrared and other wireless media.

Example embodiments also include methods. These methods can be implemented in any number of ways, including the structures described in this document. One such way is by machine operations, of devices of the type described in this document.

Another optional way is for one or more of the individual operations of the methods to be performed in conjunction with one or more human operators performing some. These human operators need not be collocated with each other, but each can be only with a machine that performs a portion of the program.

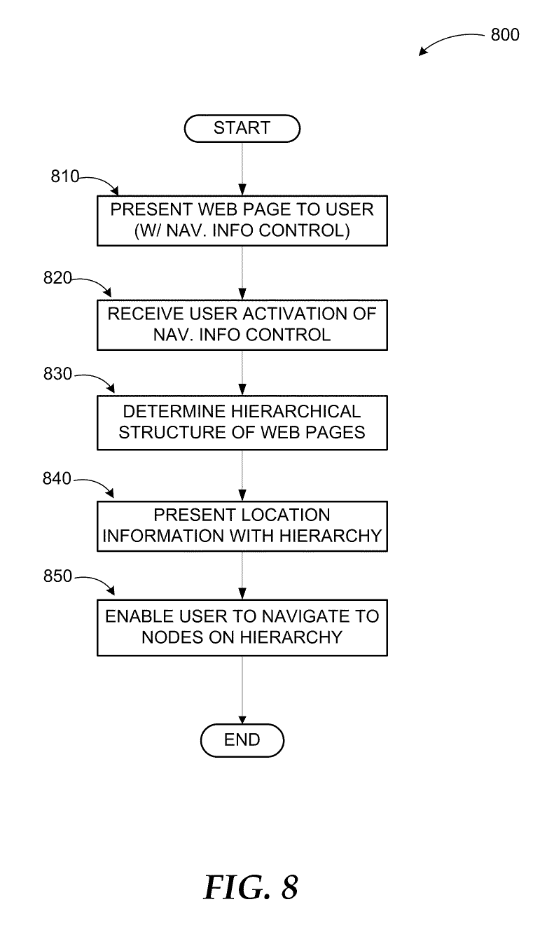

FIG. 8 illustrates a logic flow diagram for process 800 of providing a transient navigational information panel according to embodiments. Process 800 may be implemented as part of an application executed on a server or client device.

Process 800 begins with operation 810, where a web page is displayed to a user as part of the user's interactions with a web application. The web application may enable presentation of a navigational information control element as part of the browsing application displaying the web page to the user. At operation 820, user activation of the navigational information control may be received. This may be a click on a graphical button, selection of a textual link, or similar activation of a control element. At operation 830, a hierarchical structure of the web pages above and at the same level as the currently displayed web page is determined. The determination may occur on the server before the page is rendered. The control element may un-hide the menu that already contains the hierarchy. The hierarchical structure may change as the user modifies/adds/deletes pages. Therefore, the structure may be determined following the activation of the navigational information control or at least updated after the activation.

At operation 840, a present location of the currently displayed web page is presented in a transient navigational information panel within a context of its hierarchy. Thus, nodes (web pages) above and/or at the same level as the currently displayed web page may be displayed through a graphical and/or textual scheme. The information may be displayed using a linear connected diagram, a branched connected diagram, and/or a circular connected diagram. Furthermore, the user may be enabled to quickly navigate to any of the displayed nodes through navigational links displayed on the transient navigational information panel at operation 850.

The operations included in process 800 are for illustration purposes. A navigational information user interface may be implemented by similar processes with fewer or additional steps, as well as in different order of operations using the principles described herein.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A method to be executed at least in part in a computing device for providing contextual navigation information, the method comprising:
determining contextual location of a currently displayed web page;
detecting activation of a navigation information control on a browsing application user interface; and
displaying a navigation information panel presenting the contextual location of the currently displayed web page within a hierarchy of web pages and the contextual location of at least one other web page above the currently displayed web page within the hierarchy of web pages if another web page above the currently displayed web page exists.

2. The method of claim 1, further comprising:
enabling a user to navigate directly to the at least one of the presented web pages through navigational links on the navigation information panel.

3. The method of claim 1, further comprising:
enabling a user to move the navigation information panel to a desired location on the browsing application user interface.

4. The method of claim 1, further comprising:
if the currently displayed web page is within the hierarchy of web pages and not at a top level, providing the navigation information control on the browsing application user interface;
if the currently displayed web page is at the top level, providing the navigation information control with an indication that the displayed web page is the top level page.

5. The method of claim 1, further comprising:
displaying the navigation information panel at one of: a location adjacent to the navigation information control, a suitable location dynamically determined based on contents of the currently displayed web page, and a user defined location.

6. The method of claim 5, wherein the navigation information panel is transient, and the method further comprises:
animating an appearance and a disappearance of the navigation information panel.

7. The method of claim 1, further comprising:
employing at least one from a set of: a textual scheme, a graphic scheme, a color scheme, and a shading scheme to present the location information of the web pages in the navigation information panel.

8. The method of claim 1, further comprising:
employing at least one from a set of: a linear connected diagram, a branched connected diagram, and a circular connected diagram to present the location information of the web pages in the navigation information panel.

9. The method of claim 1, wherein the navigation information panel presents the location information of the web pages that have at least one of: a parent relationship, a sibling relationship, and a child relationship with the currently displayed web page.

10. A computing device for providing contextual navigation information in conjunction with a web application, the computing device comprising:
a memory;
a processor coupled to the memory, the processor executing a web application providing content to one or more client browsing applications, wherein the web application is configured to:
determine contextual location of a web page currently displayed by a client browsing application;
enable display of a navigation control at the client browsing application user interface;
upon detecting activation of the navigation control, enable display of a transient navigation information panel by the client browsing application by providing the contextual location of the currently displayed web page within a hierarchy of web pages and the contextual location of at least one other web page above the currently displayed web page within the hierarchy of web pages; and
enable a user to navigate directly to at least one of the presented web pages through navigational links on the navigation information panel.

11. The computing device of claim 10, wherein the contextual location of the web pages within a hierarchy of web pages is displayed in an indented list format with each list item being a navigational link.

12. The computing device of claim 11, wherein the indented list is a collapsible list.

13. The computing device of claim 10, wherein web application is further configured to enable the client browsing application to display an information box upon detecting the user hovering over the navigation information control to indicate that the navigation information control is a clickable surface.

14. The computing device of claim 10, wherein web application is further configured to enable the client browsing application to display the navigation information control as one of: a graphical element, a textual element, and a combination graphical/textual element if the currently displayed web page is within the hierarchy of web pages and not at a top level.

15. The computing device of claim 10, wherein content for the web pages is retrieved from at least one of: a data store associated with the computing device and other data stores associated with other computing devices accessible by the web application.

16. The computing device of claim 10, wherein the web application includes one of: an enterprise-based network, a cloud-based network, and a combination of an enterprise-based network and a cloud-based network.

17. A computer-readable storage medium with instructions stored thereon for providing contextual navigation information, the instructions comprising:
determining contextual location of a currently displayed web page;
providing a navigation information control;
displaying an information box upon detecting a user hovering over the navigation information control;
upon detecting activation of the navigation information control, displaying a navigation information panel presenting the contextual location of the currently displayed web page within a hierarchy of web pages and the contextual location of other web pages above the currently displayed web page within the hierarchy of web pages; and
enabling a user to navigate directly to at least one of the presented web pages through navigational links on the navigation information panel.

18. The computer-readable medium of claim 17, wherein navigation information panel employs one of: an indented list, a linear connected diagram, a circular connected diagram, and a branched connected diagram to present the contextual locations of the web pages along with at least one from a set of: a textual scheme, a graphic scheme, a color scheme, and a shading scheme.

19. The computer-readable medium of claim 18, wherein the instructions further comprise:
presenting the contextual location of web pages related to the currently displayed web page through a parent-child relationship and a sibling relationship within the hierarchy of web pages in a collapsible format.

20. The computer-readable medium of claim 17, wherein the presented contextual location information includes at least one of textual and graphical indication of a type of each web page.
